(19) United States
(12) Patent Application Publication
(10) Pub. No.: US 2015/0149115 A1
(43) Pub. Date: May 28, 2015

(54) Multi-function Padded Pants

(71) Applicant: Steve Belt, Newbury, MA (US)

(72) Inventor: Steve Belt, Newbury, MA (US)

(21) Appl. No.: 14/553,189

(22) Filed: Nov. 25, 2014

Related U.S. Application Data
(60) Provisional application No. 61/909,545, filed on Nov. 27, 2013.

(51) Int. Cl. A41D 13/06; A41F 9/00; G01B 21/02; A41D 1/06

(52) U.S. Cl. CPC A41D 13/065; A41D 1/06; A41F 9/00; G01B 21/02
USPC 702/166; 2/23

(57) ABSTRACT

A multi-purpose athletic garment including a pair of pants composed of an athletic performance material, the athletic garment possesses two knee pockets of durable textile material and including removably attached shock absorbing pads which may be inserted and removed. The pads allow for a user to sustain repeated impacts to the knee region like the ones often taken in a game of mini hockey or knee hockey. The pads can be removed so the pants can be worn outside of gameplay or machine washed. The multi-purpose athletic garment is utilized for knee hockey, other similar athletic events and general wear purposes.

### CROSS REFERENCE TO RELATED APPLICATION

This application takes priority from and claims the benefit of U.S. Provisional Patent Application No. 61/909,545 filed on Nov. 27, 2013, the contents of which are herein incorporated by reference.

### FIELD OF THE INVENTION

The present invention relates to clothing and athletic gear and particularly athletic pants including an area for the insertion of a protective foam pad for comfort while playing knee hockey.

### BACKGROUND OF THE INVENTION

The latest trend in the sport of hockey is the game of knee hockey. Knee hockey was invented in the 1970s, but has gained significant popularity in the recent years.

Knee hockey, as it states, is hockey played mostly on one's knees. Knee hockey is played in the comfort of your own home and is hockey on a small scale. No matter what the weather is outside, knee hockey can be enjoyed when it's too hot for ice hockey or too cold for field, street, or roller hockey. Knee hockey, also called “mini hockey”, is played with small scale sticks and nets, and foam pucks or balls. A special mat can be purchased that looks like a miniature version of an ice hockey rink although the game is typically played on household floors including but not limited to surfaces such as carpeting, hardwood, tile or concrete.

Knee hockey, more commonly known as “mini hockey” is a sporting activity that is rising in popularity with children and teens. The sport is played indoors on a floor and participants, due to the shorter length of the sticks, will typically move around on their knees. When playing in the kneeling position, the participants cannot benefit from the padding that their footwear would traditionally provide while moving. Instead the player's knees are left unpadded from impacts with the floor and the scraping and bruising that would naturally stem from such unpadded impacts.

Currently only strap-on light weight pads for the goal keeper exist which provide limited protection from impacts sustained during play, particularly for older or heavier players. There are also unsightly non-machine washable external kneepads typically used in construction that can slip off during play, damage floors, and potentially hurt other players because the pads are often made of ridged plastic. Additionally, these pads cannot be worn outside of the game, as they can inhibit flexibility, impede regular ways of walking, and restrict blood flow through the leg due to the straps.

### SUMMARY OF THE INVENTION

The instant invention, as illustrated herein, is clearly not anticipated, rendered obvious, or even present in any of the prior art mechanisms, either alone or in any combination thereof. Therefore, it is an object of the instant invention to provide a method of measurements for pants with zipper pockets which contain a foam pad insert for comfort while playing knee hockey.

Despite all the fun that can be had playing knee hockey, it can be strenuous and uncomfortable on the knees of the players, particularly on harder surfaces. Knockeys™, are pants with zipper pockets on the knee portion of the front of the pants. The zipper pockets are meant to hold and secure flexible foam pads to allow for knee hockey participants to play in comfort.

The current invention takes the pain and strain out of knee hockey. The pads that insert in to the front knee pockets provide extra cushion and support to the knee hockey player. This allows the game to be played on a wider variety of surfaces including those that, prior to the current invention, may have been considered too hard.

Additionally, Knockeys™ pants are made of athletic performance or sweat pant material, have pad pockets made of durable high-denier nylon or a similar material and have a draw string at the waist. These features allow the knee hockey players to be comfortable and have free range of motion to maximize play. Furthermore, Knockeys™ features accommodate players of a wide range of sizes, ages, and genders.

It is an object of the instant invention to introduce a multi-use full coverage garment of the protective pad type for the lower half of the body, wherein a shock absorbing pad is located within a garment pocket located at the knee region to protect the wearer against different knee impacts and abrasions.

An additional objective of the present invention is to provide a multi-use garment that has a zipper, a hook-and-loop fastener or a similar device that opens and closes the pocket where the shock absorbing pad can be secured.

Another object of the current invention is to provide two shaped shock absorbing pads, having a rectangular top with a trapezoidal bottom portion, or a similar shape which, when inserted into the proper garment pocket, are designed for optimal coverage of the knee area.

A further purpose of the instant invention is to provide a multi-use garment that functions as protective gear or fashionable pants that can be worn indoors or outdoors without the shock absorbing inserts.

Furthermore, it is an object of the current invention to introduce a multi-use garment for non-sports reasons without the padding, wherein the zipper garment pocket may be opened without cutting a seam and the pad removed and wherein the same procedure can be used to remove the pad to permit machine washing.

Additionally, it is the objective of this invention that the multi-use garment has a drawstring that enables the adjustment of the waist size and secures the garment to the user's waist.

It is a further object of the instant invention for the pants to have an elastic waistband with a drawstring tying mechanism.

It is a further object of the instant invention for the foam pad inserts to be placed in the front knee area of the pants so that entire knee is protected.

It is a further object of the invention for the foam pad inserts to be comprised of polyethylene closed cell foam, cotton or another similar substance or textile.

It is a further object of the invention for the foam pad inserts to be a trapezoid shape, a rectangular shape, a square shape or a variation of one of the above.

It is a further object of the invention for the zipper openings of the pockets to be placed horizontally or diagonally across the top of each knee.

It is a further object of the invention to measure the waist of the pants in both its relaxed and extended position.

It is a further object of the invention to measure the waist height.

It is a further object of the invention to measure the high hip and low hip of the pants.

It is a further object of the invention to measure the front and back rise-below of the waistband.

It is a further object of the invention to measure the thigh and knee portions of the pants.

It is a further object of the invention to measure the inseam of the pants, the leg opening, and hem height of the pants.

Another embodiment of the instant invention is that the zipper openings of the pockets are placed vertically on the outside of each knee.

In this respect, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1A is a front view of the Knockeys™ pants.

FIG. 1B is back view of the Knockeys™ pants.

FIG. 2 is an internal view looking of the foam pad insert.

FIG. 3 is close up view of the knee area of the pants with the foam pad insert placed in the pocket.

FIG. 4 is view inside of the waistband to show the drawstring tying mechanism.

FIG. 5 is a close up view of the additional embodiment with the zipper closing mechanism on the outside of the knee.

FIG. 6 is a chart that demonstrates the necessary measurements for each part of the pants in order to accomplish the proper finished product, in its proper size.

### DETAILED DESCRIPTION OF THE INVENTION

The detailed description set forth below is intended as a description of presently preferred embodiments of the invention and does not represent the only forms in which the present invention may be construed and/or utilized. The description sets forth the functions and the sequence of the steps for producing the system and accompanying apparatus. However, it is to be understood that the same or equivalent functions and sequences may be accomplished by different embodiments also intended to be encompassed within the scope of the invention.

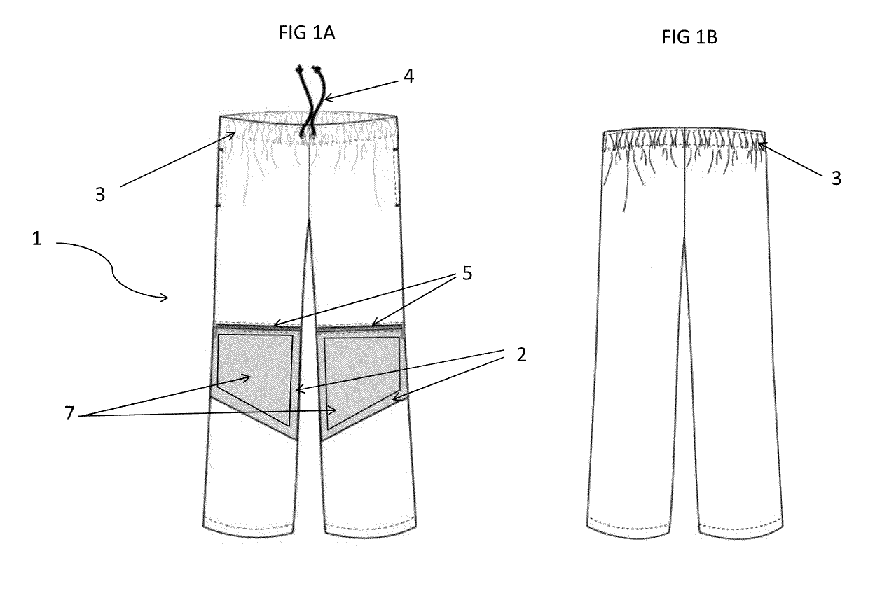

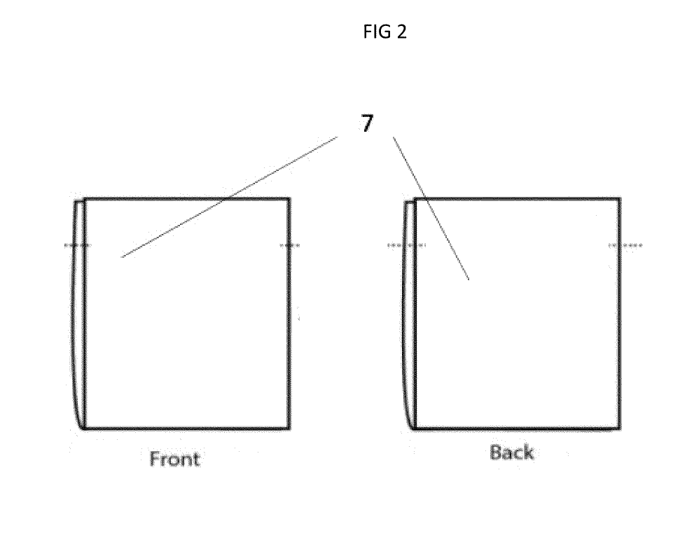

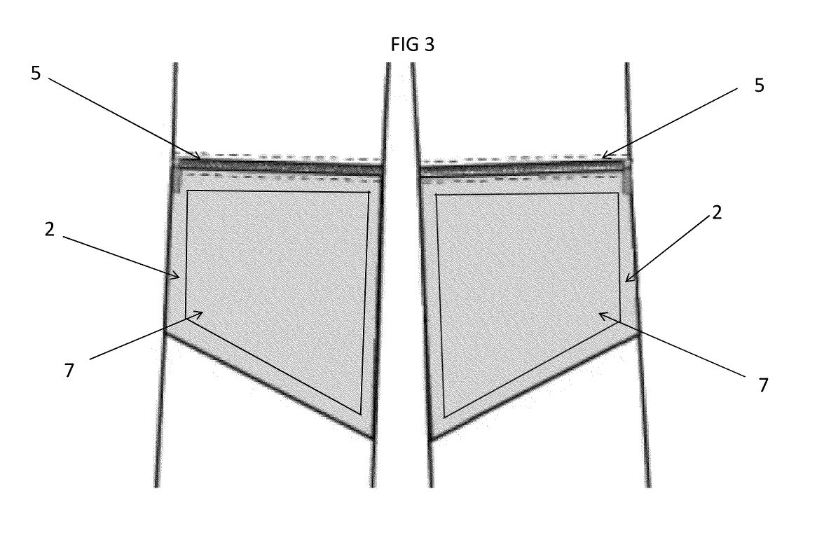

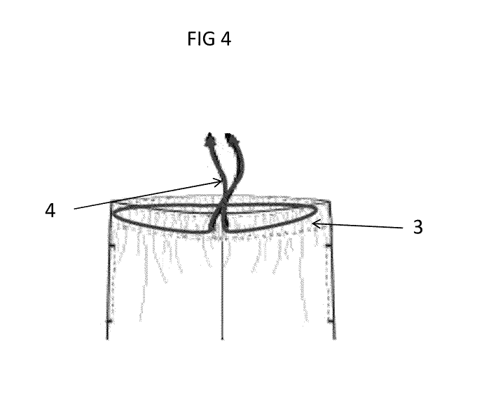

FIG. 1A-4 depict various viewpoints of the present invention and its components. The present invention includes a pair of pants 1.

The pants 1 are comprised of zipper 5 knee pockets 2. The knee pockets 2 contain a removable foam pad insert 7.

The foam pad insert 7 is made of polyethylene foam or a similar substance to create a cushion for the knees.

The zipper 5 opening mechanism is placed at the top of the pocket 2 which is located just above the top of the knee.

The waistband 3 of the pants 1 has a hollow inside so allow for the drawstring 4 to be threaded through the waistband 3 to create a tying mechanism to secure the pants 1 to the body.

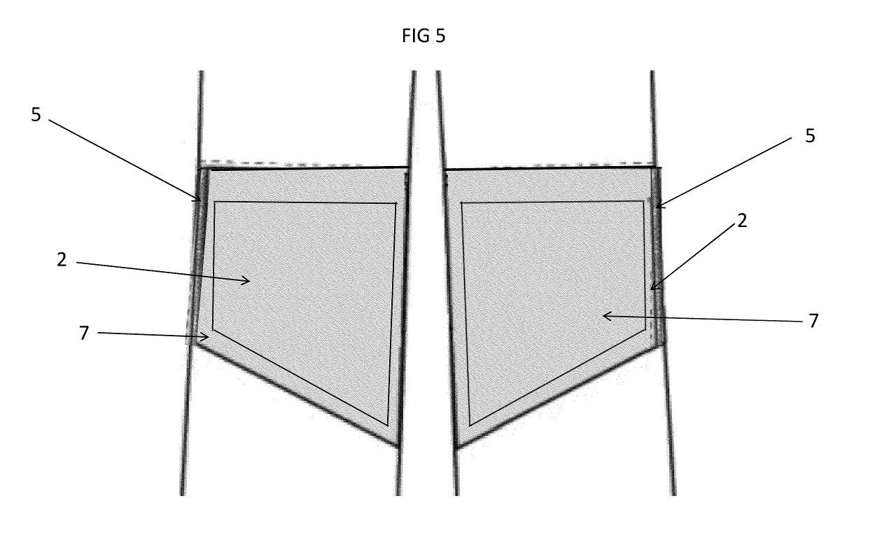

FIG. 5 depicts the additional embodiment of the instant invention. In an additional embodiment of the pants 1, the zipper 5 is on the outside of the knee pocket 2.

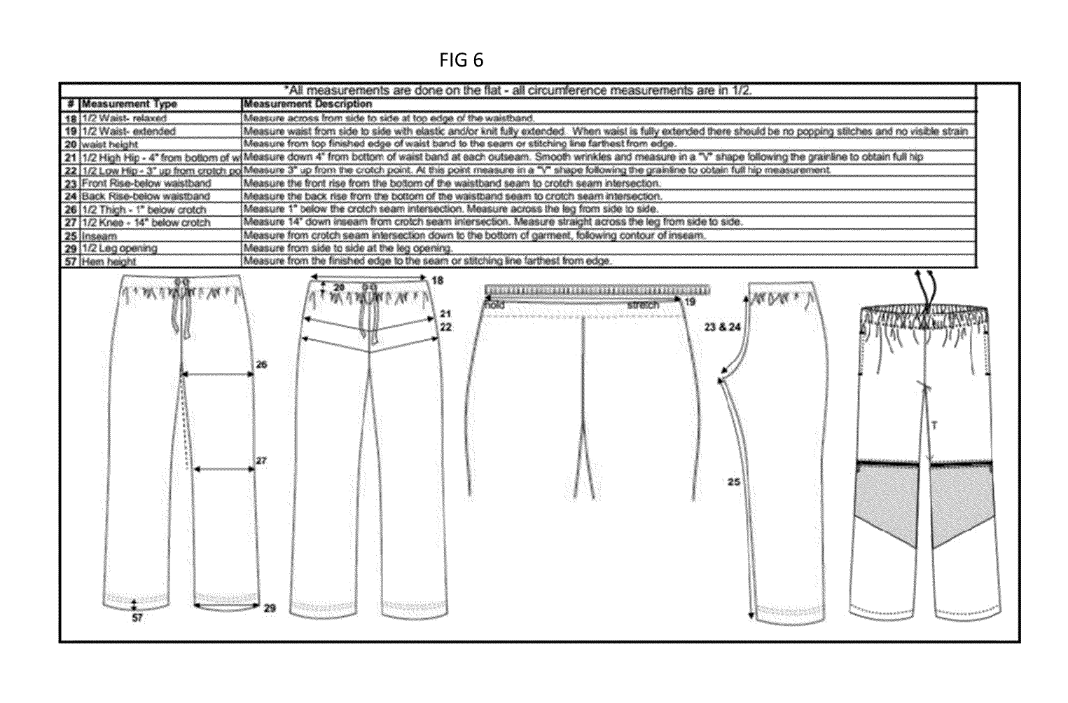

FIG. 6 shows the necessary measurements for each part of the pants 1 in order to accomplished the proper finished product, it its proper size.

The waist of the pants have to be measured in both its relaxed and extended position. To measure the waistband in its relaxed position, measure across from side to side at the top edge of waistband. This will be half of the circumference of the waistband. To measure the waistband in its extended position, measure the waistband from side to side with elastic and/or knit fully extended. The waist is fully extended when it lies flat.

To measure the waist height, measure from the top edge of the waistband to the seam or stitching line farthest from the edge.

To measure the high hip, measure down 4 inches from the bottom of the waistband at each outseam. Smooth the wrinkles and measure in a “v” shape following the grainline to obtain the full hip. This measurement is half of the circumference of the leg of the pants.

To measure the low hip, measure down 3 inches up from the crotch point. At this point, measure in a “v” shape following the grainline to obtain the full hip measurement. This measurement is half of the circumference of the leg of the pants.

To measure the front rise-below waistband, measure the front rise from the bottom of the waistband seam to crotch seam intersection.

To measure the back rise-below waistband, measure the back rise from the bottom of the waistband seam to crotch seam intersection.

To measure half of the circumference of the thigh of the pants, measure 1 inch below the crotch seam intersection and then measure across the leg from side to side.

To measure half of the circumference of the knee, measure 14 inches down the inseam from the crotch seam intersection and then measure straight across the leg from side to side.

To measure the inseam, measure from crotch seam intersection down to the bottom of the garment, following the contour of the inseam.

To measure half the circumference of the leg opening, measure from side to side at the leg opening.

To measure the hem height, measure from the finished edge to the seam or stitching line farthest from the edge.

In a further embodiment, depicted is a multi-function pants system which may comprise an elastic waist band that can be adjusted by a drawstring that is threaded into the waist band and is exposed in the front. Further, the multi-function pants comprise a hip pocket slit and the zipper assembly of the garment pocket for the shock absorbing pad are depicted. Additionally, there are open leg holes at the bottom of each leg of the multi-function pants.

In one embodiment of the multi-function pants, the system will be constructed of a polyester heavy wicking pique knit that is durable and lightweight. The drawstring will be constructed of a durable rope, string or skate/shoelace. An additional visual shows an external close up view of the zipper assembly. The zipper will run along the zipper teeth positioned at the top opening of the garment bag which holds the shock absorbing pad. The zipper assembly consists of a small handle and zipper head which is designed to connect and disconnect the zipper teeth. The material of construction will be of a metallic or durable plastic material.

A further embodiment depicts the interior of the knee portion of the multi-function pants where the garment bag is positioned. The shock absorbing pad may be stored snuggly into the bag and is secured by the zipper assembly and the zipper teeth. The garment bag consists of a large bag that is sewn onto the legs of the multi-function pants, and is constructed of a material intended to withstand significant friction.

In yet another embodiment the multi-purpose pants which may consist of an elastic waist belt and a drawstring that is used to further secure the pants to the user exist. And in an alternative embodiment of flexible shock absorbing pad, the pad may comprise a squared top and a trapezoidal bottom and may be constructed of a flexible lightweight material that comprises shock absorbing properties.

The side of multi-function pants has a slit which is the entrance to the hip pocket bag positioned on either side of the pant legs. The hip pocket bag will be constructed of a similar material as the multi-function pants.

There has thus been outlined, rather broadly, the more important features of the Knockeys™ multipurpose pants in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

What is claimed is:

1. An athletic protective pant mechanism comprising:
a set of knee pockets;
a closing mechanism;
a foam pad insert; and
a drawstring waistband.

2. The athletic protective pant mechanism of claim 1 wherein the closing mechanism comprises a zipper mechanism.

3. The athletic protective pant mechanism of claim 1 wherein the set of foam pad inserts comprise polyethylene foam or similar substance and are in the shape of a trapezoid, rectangle, square or other similar shape intended to provide adequate knee coverage.

4. The athletic protective pant mechanism of claim 1 wherein the waistband is hollow to allow for the threading of the drawstring.

5. A method of generating measurements for the production of athletic protective pants comprising the steps of:
combining a series of calculations to attain proper sizing and fit to accommodate the intended uses of the pants;
measuring a half of the circumference of a waistband in a relaxed position; and,
measuring across from side to side at a top edge of the waistband.

6. The method of generating measurements for the production of athletic protective pants of claim 5 further comprising the steps of:
measuring half of the circumference of the waistband in an extended position; and,
measuring the waistband from side to side with elastic and/or knit fully extended.

7. The method of generating measurements for the production of athletic protective pants of claim 6 further comprising the steps of:
measuring the waist height; and,
measuring from the top edge of the waistband to a seam stitching line farthest from the edge;

8. The method of generating measurements for the production of athletic protective pants of claim 7 further comprising the steps of:
measuring half of the circumference of the high hip;
measuring down 4 inches from the bottom of the waistband at each outseam;
smoothing the wrinkles and measure in a “v” shape following the grainline to obtain the full hip.

9. The method of generating measurements for the production of athletic protective pants of claim 8 further comprising the steps of:
measuring half of a circumference of a low hip;
measuring down a quantity of 3 inches up from a crotch point; and
measuring in a “v” shape following a grainline to obtain a full hip measurement.

10. The method of generating measurements for the production of athletic protective pants of claim 9 further comprising the steps of:
measuring a front rise-below waistband; and,
measuring a front rise from the bottom of a waistband seam to a crotch seam intersection.

11. The method of generating measurements for the production of athletic protective pants of claim 10 further comprising the steps of:
measuring a back rise-below waistband; and,
measuring a back rise from the bottom of the waistband seam to the crotch seam intersection.

12. The method of generating measurements for the production of athletic protective pants of claim 11 further comprising the steps of:
measuring half of a circumference of a thigh of the pants;
measuring a quantity of one inch below a crotch seam intersection; and,
measuring across a leg from side to side.

13. The method of generating measurements for the production of athletic protective pants of claim 12 further comprising the steps of:
measuring half of a circumference of the knee;
measuring a quantity of fourteen inches down the inseam from the crotch seam intersection; and,
measuring straight across the leg from side to side.

14. The method of generating measurements for the production of athletic protective pants of claim 13 further comprising the steps of:
measuring the inseam; and,
measuring from the crotch seam intersection down to the bottom of the garment by following a contour of the inseam.

15. The method of generating measurements for the production of athletic protective pants of claim 14 further comprising the steps of:
measuring half a circumference of the leg opening; and,
measuring from side to side at a leg opening.

16. The method of generating measurements for the production of athletic protective pants of claim 15 further comprising the steps of:
measuring a hem height; and,
measuring from the finished edge to the seam stitching line farthest from the edge.

17. An article of apparel comprising:
an elastic waistband;
a drawstring;
at least two hip pockets;
a zipper assembly with corresponding zipper teeth;
at least two garment pockets; and
at least one shock absorbing pad.

18. The article of apparel comprising at least one cushioning element of claim 17 wherein the article of apparel comprises of a set of pants.

19. The article of apparel comprising at least one cushioning element of claim 17 wherein the elastic waist band forms the top of the multi-use pants with an elastic band sewn into the fabric to help secure the pants to the user.

20. The article of apparel comprising at least one cushioning element of claim 17 wherein the drawstring is constructed of nylon, cotton or another durable material and is threaded through the waist band entering and exiting from two slits positioned on the front of the waist band.
